(19) United States
(12) Patent Application Publication
(10) Pub. No.: US 2004/0243450 A1
(43) Pub. Date: Dec. 2, 2004

(54) Method, system, and computer program product for real property metric monitoring

(76) Inventors: Thomas James Bernard JR., San Francisco, CA (US); Elvin Alvaro Valverde JR., Benicia, CA (US)

Correspondence Address: MICHAEL E. WOODS, PATENT LAW OFFICES OF MICHAEL E. WOODS, 112 BARN ROAD, TIBURON, CA, 94920-2602, US

(21) Appl. No.: 10/744,909

(22) Filed: Dec. 22, 2003

Related U.S. Application Data
(63) Continuation-in-part of application No. 10/452,405, filed on Jun. 2, 2003.

(51) Int. Cl. G06F 17/60

(52) U.S. Cl. 705/4

(57) ABSTRACT

Disclosed is a monitoring service that includes the steps of aggregating a mortgage insurance payer record for each of a plurality of mortgagors into a set of mortgage insurance payment records, wherein said plurality of mortgagors include mortgagors paying a plurality of different mortgage insurers; monitoring a set of one or more potential mortgage insurance removal triggering events and flagging one of said mortgage insurance payer records that satisfy any criterion associated with any potential mortgage insurance removal triggering event as a potential mortgage insurance removal record, wherein a criterion relates to property asset appreciation; and notifying a mortgagor associated with said potential mortgage insurance removal record that said mortgagor may have an option to remove said mortgage insurance component. A preferred embodiment includes a message box in an electronically accessible format (e.g., on a client webpage), a content of the messagebox dynamically assembled into a content of the webpage, the messagebox providing communication to a client from a product or service provider having access to selected information available through the system (such as that available on the notice, for example).

### CROSS-REFERENCE TO RELATED APPLICATIONS

This application is a CONTINUATION-IN-PART of U.S. patent application Ser. No. 10/452,405 Entitled “METHOD AND SYSTEM FOR MORTGAGED PROPERTY MORTGAGE INSURANCE MONITORING” filed 2 Jun. 2003, the disclosure of which is hereby expressly incorporated by reference for all purposes.

### BACKGROUND OF THE INVENTION

The present invention relates generally to mortgage insurance, and more specifically to monitoring private mortgage insurance payment prerequisites to identify mortgagors that may be able to terminate private mortgage insurance payments while providing those mortgagors with resources to remove private mortgage insurance payments when possible.

Private mortgage insurance is a mortgage insurance that is provided by a private mortgage insurance company. This insurance protects a mortgagee against loss if a mortgagor defaults on mortgage payments. When a person purchases a home and finances some of the purchase price of the home, the mortgagor may be required by the mortgagee to obtain a private mortgage insurance policy, paid for by the mortgagor for the benefit of the mortgagee. When a loan-to-value (LTV) percentage of the home exceeds eighty percent, most mortgagees require this insurance policy.

The Homeowners Protection Act of 1998—which became effective in 1999—establishes rules for automatic termination and borrower cancellation of private mortgage insurance on home mortgages. These protections apply to certain home mortgages signed on or after Jul. 29, 1999 for the purchase, initial construction, or refinance of a single-family home. These protections do not apply to government-insured FHA or VA loans or to loans with lender-paid private mortgage insurance.

For home mortgages signed on or after Jul. 29, 1999, private mortgage insurance must—with certain exceptions—be terminated automatically when the mortgagor reaches twenty-two percent equity in the mortgagor's home based on the original property value, if mortgage payments are current. Private mortgage insurance also can be canceled, upon request—with certain exceptions—when the mortgagor reaches twenty percent equity in the mortgagor's home based on the original property value, if mortgage payments are current.

There are some exceptions, such as if the loan is “high-risk.” Another is if the mortgagor has not been current on payments within the year prior to the time for termination or cancellation. A third is if there are other liens on the property. For loans meeting these conditions, private mortgage insurance may continue to be requested.

For mortgages executed before Jul. 29, 1999, a mortgagor can request to have the private mortgage insurance canceled once the mortgagor exceeds twenty percent equity in the home. But federal law does not require a lender or mortgage servicer to cancel the insurance.

Each State can also have specific laws regarding the criteria for the removal of private mortgage insurance, with these State-enacted criteria varying from State to State. Even if a mortgagor may not be legally entitled to remove private mortgage insurance, mortgagees may remove private mortgage insurance when requested under the right conditions.

On a $100,000 loan with ten percent down ($10,000), private mortgage insurance might cost forty dollars each month. Removal of the private mortgage insurance therefore would save four hundred eighty dollars a year and many thousands of dollars over the loan. As Federal Law requires only an annual reminder from a mortgagee or mortgage servicer regarding removal of private mortgage insurance, and there is little if any incentive for a mortgagee or insurance company to remove this insurance, it is often a mortgagor's responsibility to initiate private mortgage insurance removal. However, given all the conditions it can be difficult for mortgagors to understand when they are legally entitled to remove private mortgage insurance.

There are other types of metrics/indicia that may be gathered consequent to ownership of real property that may offer similar information benefits or cost-savings to a homeowner, such as for example, home insurance, mortgage rates, and property tax. Facilitating contact between real property services/products-related professionals and homeowners/prospective homeowners for assistance with these services and products is also advantageous to both sets of parties.

Accordingly, what is needed is a system, method, and computer program product for real property metric monitoring including collecting and analyzing prerequisites and indicia for each of a plurality of homeowners to assist them in reducing the costs associated with real property ownership. The present invention addresses such a need.

### SUMMARY OF THE INVENTION

Disclosed is a monitoring service that includes the steps of aggregating a mortgage insurance payer record for each of a plurality of mortgagors into a set of mortgage insurance payment records, wherein said plurality of mortgagors include mortgagors paying a plurality of different mortgage insurers; monitoring a set of one or more potential mortgage insurance removal triggering events and flagging one of said mortgage insurance payer records that satisfy any criterion associated with any potential mortgage insurance removal triggering event as a potential mortgage insurance removal record, wherein a criterion relates to property asset appreciation; and notifying a mortgagor associated with said potential mortgage insurance removal record that said mortgagor may have an option to remove said mortgage insurance component. A preferred embodiment includes a message box in an electronically accessible format (e.g., on a client webpage), a content of the messagebox dynamically assembled into a content of the webpage, the messagebox providing communication to a client from a product or service provider having access to selected information available through the system (such as that available on the notice, for example).

The system, method, and computer program product tracks real property metrics, e.g., mortgage insurance payment prerequisites, for each of a plurality of homeowners (for example mortgagors) and assists them in reducing costs (e.g., removing mortgage insurance) when possible. The system, method, and computer program product of the preferred embodiment, among other types of metrics, and indicia notifies a mortgagor when a cost savings may be possible, such as for example removing private mortgage insurance, changing loans, changing homeowner's insurance, lowering property taxes, and provides resources to assist in effectuating the cost-savings, including use of a messagebox for communication from a provider to a homeowner to assist with effectuating cost-savings.

### BRIEF DESCRIPTION OF THE DRAWINGS

FIG. 1 is a preferred embodiment for a real property metric monitoring system 100;

FIG. 2 is a flowchart for a preferred embodiment of a monitoring service;

FIG. 3 is a first page of a copy of a report generated from the monitoring system;

FIG. 4 is a second page of the copy of the report shown in FIG. 3;

FIG. 5 is a first page of a copy of a client entry interface for the monitoring system;

FIG. 6 is a second page of the copy of the interface shown in FIG. 5; and

FIG. 7 is a copy of a client manager interface for use with the monitoring system.

### DETAILED DESCRIPTION

The present invention relates to tracking and using real property metrics of many types, including property tax, home insurance, mortgage costs, and mortgage insurance payment prerequisites for each of a plurality of homeowners and assisting them in monitoring/reducing costs associated with real property ownership when possible. In addition, the present invention enables buyers, sellers, and other professionals providing goods and services to buyers and sellers in real property transactions with tools and information to manage many client relationships, and real property-related events. The system, method, and computer program product of the preferred embodiment also relates to notification to a mortgagor when removing mortgage insurance may be possible and providing resources to assist in removing the insurance when it is possible. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

To simplify the discussion of the present invention, a specific implementation is described, namely removal or cancellation of private mortgage insurance. The present invention includes recordation of metric records and one or more triggering events related to the metric or metric associated data. When particular criteria are satisfied, based upon the metric record and the triggering event, a notice is provided to a homeowner to report the triggering event (which typically reports on the status of the metric or the triggering event, or provides assistance in responding to a condition identified by the triggering event that is beneficial to the homeowner). Triggering events relate to private mortgage insurance removal/cancellation, property tax savings, homeowner's insurance premium levels, mortgage rates, and other services and products provided by a third party. Sometimes the third party is a governmental entity (in the case of property taxes), a lender, an insurance provider, or other entity. The specific example of a metric record for a homeowner record includes private mortgage insurance carrier, terms, and type, and the metric triggering event relates to removal and/or cancellation of the private mortgage insurance premium.

For purposes of the following discussion, mortgage insurance is defined to include private mortgage insurance, non-private mortgage insurance and mortgage guaranty insurance. Further, mortgage insurance removal includes both mortgage insurance cancellation and mortgage insurance elimination and other procedures for cessation of payment of mortgage insurance premiums. Cancellation refers to stopping the payment of mortgage insurance premiums for a mortgage while retaining the mortgage and elimination refers to obtaining a new mortgage that does not include a mortgage insurance premium payment.

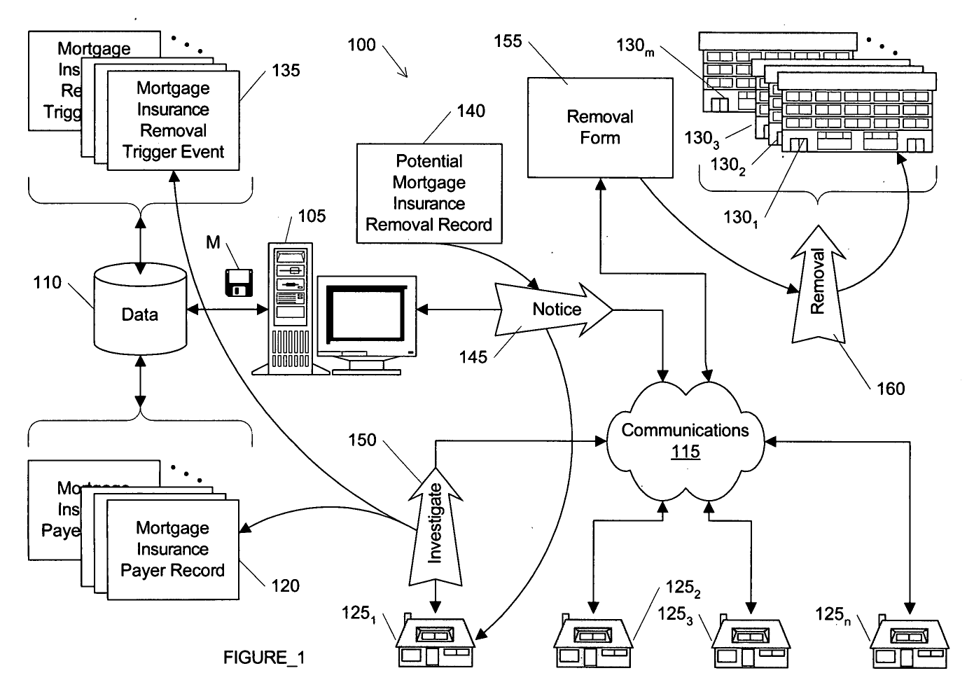

FIG. 1 is a preferred embodiment for a real property metric monitoring system 100. Monitoring system 100 includes a computing system 105 coupled to a database 110 and a communications system 115. Computing system 105 is represented by a single computing platform, but in different embodiments computing system 105 may be any of the multitude of computing platforms well-known in the art for adding/modifying/deleting/reading data in database 110 according to one or more instructions (stored for example in non-volatile memory in computing system 105 or on removable media M) in one or more application or computer processes operating on computing system 105.

Database 110 is represented as a single electronic repository of data records coupled to computing system 105 to simplify the description of the present invention. However, there are many types and implementations of database 110 that are well-known, including flat file, relational, distributed, etc. Different implementations of monitoring system 100 may include one or more databases of virtually any type and structure.

Database 110 stores a mortgage insurance payer record 120 for each of a plurality of mortgagors 125ₙ. Each mortgagor 125ᵢ has a mortgage from one of a plurality of different financial institutions (e.g., mortgagees and/or mortgage servicers) 130ₘ. Information on each mortgage is recorded on a payer record 120 and includes payer identification and data, property identification and data, and mortgage identification and data. The specific types of information recorded in each record may vary from implementation from implementation, or from payer record to payer record, but at a minimum should include information regarding payer contact and property identification.

Data for mortgage insurance payer records may be provided from a primary source, a secondary source or a combination of the two. A primary source is a provider of information that is a homeowner, mortgagor, lender, real estate agent, real estate broker, mortgage broker, mortgage insurer, any of their agents or other entity having direct information. Secondary sources are all non-primary sources of information.

Database 110 also stores a plurality of mortgage insurance removal trigger event records 135. Trigger event records 135 describe criteria for removing mortgage insurance payments of the mortgagors 125. These criteria include Federal, State and Local requirements, standards by financial institutions 130, standards for classes of mortgages and/or standards for the insurance industry. Different implements in different localities and countries of the world for different groups of mortgagors and mortgagees will use different trigger event records 135. For example, when a mortgagor's principal balance of a mortgage is less than eighty percent (80%) of the current property value. Other criteria and removal conditions may be applicable.

Computer system 105 is coupled to communications system 115 for interfacing with the mortgagors 125 and financial institutions 130. Communications systems 115 include telecommunications systems (e.g., telephone/fax), printed correspondence (e.g., US Postal Service, overnight couriers, messengers) and network (e.g., Internet) for transmitting notices and other correspondence.

Computing system 105, as explained further below, will identify one or more payer records 120 as potential mortgage insurance removal records 140 by comparing payer records with triggering events. Computing system 105 will create a notice 145 for mortgagors 125ᵢ associated with the one or more of removal records 140. Notice 145 provides information to the associated mortgagors that it/they may be able to remove the mortgage insurance premium payments. Additionally, the preferred embodiment provides each such mortgagor with a resource, or a location of one or more resources to aid the mortgagor in: (1) investigating whether the mortgage insurance premium may in fact be able to be removed; and/or (2) initiating a removal process.

In the preferred embodiment, notice 145 is an electronic transmission (e.g., an e-mail) that includes an active link (e.g., a universal resource locator or URL) to a personalized resource page configured by computing system 105 on a mortgage insurance removal webservice. Other types of notices may be used however. The webservice in the preferred embodiment is a part of computing system 105, but in other implementations the webservice may be provided as part of another computing system or resource.

In response to notice 145, one or more mortgagors 125 may investigate by initiating an investigate process 150. Investigate process 150 includes the mortgagor comparing details regarding its mortgage and its property against the relevant triggering events to determine whether any of the mortgage removal requirements in the triggering event(s) are satisfied. In the preferred embodiment, investigate process 150 is initiated automatically when mortgagor 125 uses an electronic URL link in notice 145 of the preferred embodiment.

Actuating the link of the preferred investigate process 150 presents mortgagor 125 with its payer record 120 and the applicable triggering event(s) 135. The preferred embodiment also presents mortgagor 125 with an ability to update/replace/supplement information from its payer record 120 and mortgage insurance removal resources to aid mortgagor 125 in its investigation and removal of its insurance premium.

Mortgage insurance removal resources include resources for facilitating removal of mortgage insurance premiums, including appraisers, lenders, mortgage brokers, monitoring services, real estate agents, attorneys, appraisal resources, calculators and amortization tables, removal procedures and guidelines, form and letter template libraries as well as other information deemed useful.

When mortgagor 125 establishes that it may remove its mortgage insurance, computer system 105 may assist in preparation of a removal form 155. Computer system 105, or mortgagor 125 in cooperation with computing system 105, initiates a remove process 160 with its financial institution 130. Remove process 160 includes, in the preferred embodiment, a demand/request for removal of mortgage insurance premiums, a statement of applicable removal criteria and supporting data/documentation for establishing satisfaction of the applicable removal criteria. Alternatively, it may include the application for a new loan that does not require mortgage insurance.

In operation, monitoring system 100 enters mortgage insurance payer records 120 for each mortgagor 125, and mortgage insurance removal trigger event records 135 for the mortgagors and financial institutions. The data for the payer records is provided from primary sources, secondary sources, and/or a combination of these sources. Monitoring system 100 may be provided to mortgagors 125, financial institutions 130, or other third party based upon fee-based subscription and/or pay-per-use and/or other compensation system including a free service or sponsor-paid service.

In the preferred embodiment, payer record 120 includes mortgagor name, contact information (including e-mail), property identification (e.g., address, parcel number, and general property characterizations such as square footage, number and types of rooms, and other valuation parameters), property valuation history, and mortgage identification (including balance, interest rate, term, mortgagor, and mortgage insurance premium information) obtained from one or more primary sources. In alternate preferred embodiments, payer record 120 may be populated by data obtained or derived from secondary sources, using estimated or average values for selected information in the record.

Periodically, computing system 105 updates payer records 120 and periodically compares one or more payer records 120 against one or more trigger events 135. Computing system 105 uses one or more thresholds for determining how close a particular payer record 120 is to satisfying applicable removal criteria. For example, some mortgagors may want to know that applicable criteria will be met at some particular time in the future (e.g., six months from now), whether the criteria is satisfied based upon current data, or whether the criteria may be satisfied based upon current data.

Most of the criteria include a comparison of an equity interest in a mortgaged property and a comparison of that interest to a property valuation. Equity interest is a composite of the property valuation less the mortgage balance. Computing system 105 periodically updates payer records to estimate current equity interest. Payer records 120 are updated to reflect principal balance reductions (either from a primary source or estimated based upon secondary source information) and to reflect property valuation increases (again, either from a primary source or estimated based upon secondary source information).

The preferred embodiment uses computing system 105 to estimate changes in property valuations through use of valuation services, such as for example automated valuation models. Examples of such automated valuation models include AVMFinder™ and Freddie Mac's Home Value Explorer^{SM} from Dataquick Information Systems of San Diego, Calif. and Home Price Analyzer from Basis 100 of Toronto, Ontario, Canada. This is because it is anticipated that periodic actual appraisals will be unavailable as most mortgagors do not have their property appraised with regularity. Monitoring system 100 is able to use actual appraisals that are available.

For those payer records 120 that meet the threshold conditions of the applicable removal events, computing system 105 flags them as potential mortgage insurance removal records 140. Computing system 105 sends notice 145 to mortgagors 125 associated with each flagged removal record 140 using the selected communications medium.

As discussed above, the preferred embodiments provides notice 145 in electronic form having an active link accessing a personalized webpage on the mortgage insurance removal webservice for the proper mortgagor 125.

When mortgagor 125 actuates the active link, mortgagor is directed to the personalized webpage and starts investigate process 150 described above. Data from payer record 120 applicable to mortgagor 125 populates the personalized webpage, and other derived/calculated data may also be included, as well as the applicable removal trigger criteria.

Mortgage insurance removal resources are also available on the webpage and are automatically and/or manually applied against the webpage data to facilitate investigation 150.

When mortgagor 125 determines that it wants to remove its mortgage insurance payment and that it has sufficient basis to do so, mortgagor 125 again uses the mortgage insurance resource tools to generate applicable removal form 155. Mortgagor 125 either directly, or by use of computing system 105, initiates remove process 160 by directing removal form 155 to the appropriate financial institution 130.

While the preferred embodiment obtains most payer record data from primary sources, an alternate preferred embodiment uses secondary sources to populate the data fields and average/estimated values where necessary. Notices 145 derived from this type of data are more informational and solicit a particular mortgagor 125 to investigate removing mortgage insurance payment by substituting primary source/actual data for secondary source/estimated data.

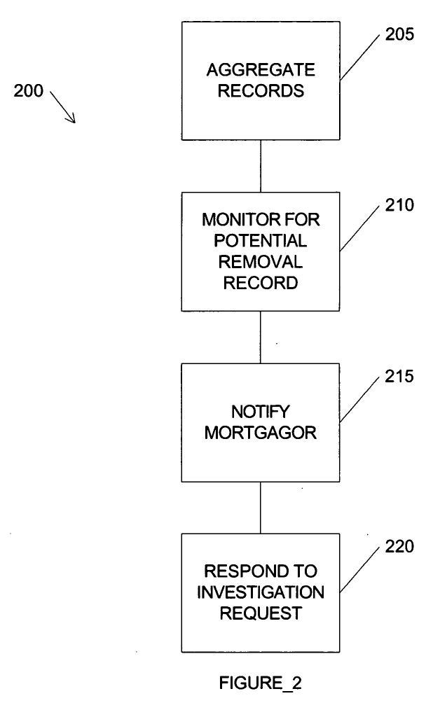

FIG. 2 is a flowchart for a preferred embodiment of a monitoring service 200. Monitoring service 200, in the preferred embodiment, is implemented by monitoring system 100 shown in FIG. 1 using computer program instructions stored on medium M and operable on computing system 105, though service 200 may be implemented on other systems using other program instructions as well.

Monitoring system 200 begins at step 205 and aggregates a plurality of payer records into a datastorage system. For example, records 120 shown in FIG. 1 may be compiled from one or more primary sources, one or more secondary sources, or a combination of both. The necessary and desirable information is recorded for multiple mortgagors having mortgages with multiple mortgagees having different mortgage insurance payment conditions.

After payer records are aggregated, process 200 proceeds to step 210 to monitor for one or more potential removal records. Monitoring step 210 is performed periodically and applies current payer record information (including any property valuation updates as described above) against a set of mortgage insurance removal triggering events such as those included in events 135 shown in FIG. 1. Each mortgagee has one, but some have multiple, set of prerequisites that must be met before it will remove a mortgage insurance payment. In some cases, a mortgagee may voluntarily remove an insurance payment when not required when a different set of prerequisites are satisfied. Process 200 may test for either or both types of prerequisites.

Monitoring step 210 applies a set of mortgage insurance removal triggering events against a set of payer records and identifies a set of potential mortgage insurance removal records from the payer records. In the preferred embodiment, all triggering events are applied against all payer records periodically, for example once a month. In other cases, monitoring step 210 is initiated when a payer record is updated with new information.

In some embodiments, different sets of records may be monitored more frequently than other sets, and different sets of triggering events may be used. For a fee-based service, frequency of monitoring and the resources used in updating and monitoring may vary based upon subscription levels and whether the payer record is derived from a primary or a secondary source.

For example, when a payer record is based on secondary source data, some of the mortgage and insurance payment information may include estimates and average information. In some implementations, a payer record may be created based simply on general public information such a selling price and general property parameters (e.g., location, size, number and type of rooms). In these cases, monitoring process 200 may not know with certainty whether a triggering event is satisfied or even whether a mortgage exists or whether the mortgagor has insurance, but process 200 may determine that a triggering event may be satisfied based upon some reasonable set of values estimated or deduced for the property. Process 200 sets one or more thresholds to determine how close a triggering event must be satisfied before a payer record may be flagged based upon the triggering event. In some embodiments, different sets of payer records may have different classes of thresholds. For example, some records may be flagged when a relevant prerequisite is satisfied. Other records may be flagged when process 200 determines that a relevant prerequisite may be satisfied at some definite point in the future, say three months from today. Of course, other thresholds may be used.

After monitoring step 210, process 200 notifies mortgagors at step 215. Process 200 issues a notice to selected mortgagors based upon a predefined set of conditions. For example, process 200 may issue notices to only those mortgagors associated with the potential removal records identified in step 210. In other embodiments, every mortgagor receives a notice either indicating that the mortgage insurance payment may be removed or when the mortgage insurance payment will be able to be removed. Additional information from the payer record may be included in the notice, such as valuation estimates and mortgage principle. Different mortgagors may receive notices of different types at different rates depending upon the particular implementation, for example, a premium subscription level may result in monthly notices that include property valuation estimates and other property data while a basic level may result in minimum information notices at six month intervals.

After notify step 215, process 200 advances to step 220 to respond to investigation requests. In the preferred embodiment, the notify step 215 includes an investigate reference to assist a mortgagor in evaluating whether an insurance payment removal condition is in fact satisfied, and if not, when it might be satisfied. The investigate reference, in the preferred embodiment, is an active uniform resource locator (URL) embedded into an electronic notice e-mailed to mortgagors. This URL directs the mortgagor to a private webspace in which selected portions of the mortgagor's payer record, the related triggering events, and other resources are available to assist the mortgagor in investigating whether the insurance payment may be removed. Some of the resources are automatically applied to the payer record and/or triggering event data, and others are manually applied. In the preferred embodiment, the mortgagor is able to edit selected information from the payer record and/or triggering event to improve the results of the application of the desired resources. Some of the resources include tools to aid the mortgagor in documenting and requesting the removal of the insurance payment when the conditions warrant such removal. For example, the resources include model letter templates, appraisal recommendations, and refinancing options.

The present invention for a monitoring service may be provided as a computer program product that may include a machine-readable medium having stored thereon instructions that can be used to program a computer (or other electronic devices) to perform a process according to the present invention. The machine-readable medium may include, but is not limited to, floppy disks, optical disks, CD-ROMS, magneto-optical disks, ROMS, RAMS, EPROMS, EEPROMS, magnetic or optical cards, or any type of media/machine-readable medium suitable for storing electronic instructions.

The preferred embodiment of the present invention is implemented as a monitoring service that is used as an aid to removing private mortgage insurance payments. The preferred embodiment uses a loan-to-value ratio of indebtedness of a real estate property as compared to the property's current value. Systems of the present invention are in place to track real estate information, loan information and property valuation and to selectively compare the proper information at suitable intervals.

Another preferred embodiment of the present invention tracks equity and/or loan-to-value ratios of real estate properties. Equity and/or loan-to-value information is useful for reasons other than removing private mortgage insurance. Some of these reasons include: knowing when to refinance a property; planning for a balanced wealth portfolio; planning for retirement; planning a move; discovering that one can afford an additional property (e.g., in the mountains or on the beach); reassessing property taxes, and preparing for college expenses for dependents or property owner, among other uses. Implementations of the present invention may use the monitoring service to track and notify property owners of one or more of these events in addition to, or in lieu of, removing private mortgage insurance payments. In some implementations, the monitoring service may simply notify the property owner of the current property value, equity and/or loan-to-value ratio.

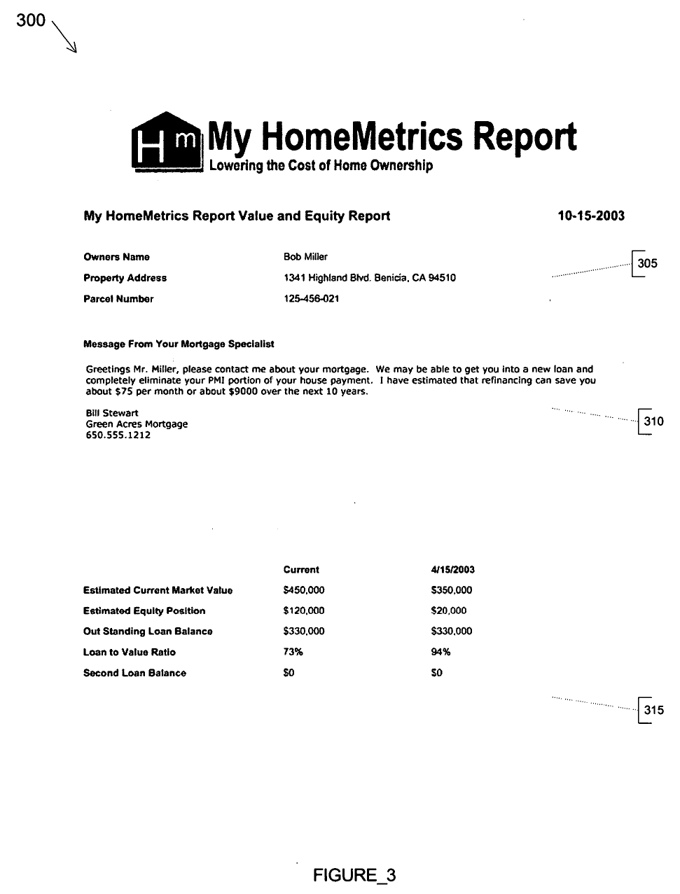

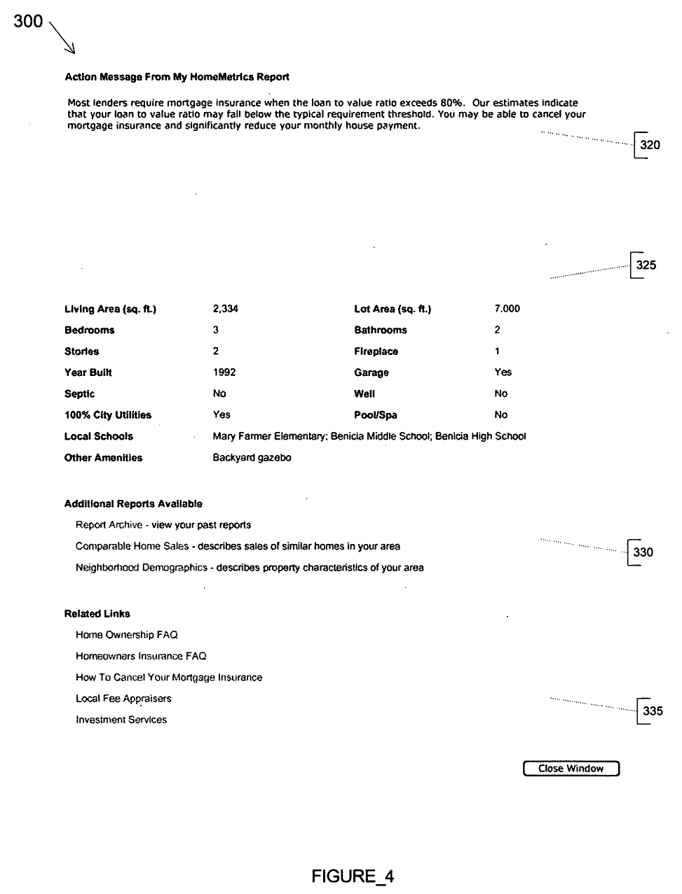

FIG. 3 is a first page of a copy of a report 300 generated from monitoring system 100. FIG. 4 is a second page of report 300 shown in FIG. 3. In some instances and for some implementations, report 300 will be used by system 100 as notice 145 shown in FIG. 1.

Report 300 includes a number of data areas, including a client-property identification area 305, a message box 310, and property equity information area 315 shown in FIG. 3. FIG. 4 includes an action message area 320, a property summary area 325, an additional services area 330, and an additional resources area 335.

ID area 305 summarizes the client name and includes a property description. In some implementations, a client may include multiple properties in report 300. Message box 310 is a personalized, targeted communication from a real property professional (in this example, a mortgage specialist though other professionals may be included in addition or in lieu of the mortgage specialist). The real property professional may have access to some or all of the client's data (as agreed by the client and as implemented) permitting the professional to include specific, helpful information applicable to the particular client or group of clients sharing a common attribute.

Information area 315 includes information about the property loan to value and the components of the calculation for a current period and a last reported period. Information area 315 includes an estimated current market value, an estimated equity position based upon the estimated market value and outstanding mortgage balance(s).

Action message area 320 includes any relevant analysis by system 100 regarding trigger events (actual or potential) for any of the metrics/indicia monitored on behalf of the client for the identified property.

Property summary area 325 provides an overview of the relevant property parameters used by monitoring system 100. The parameters chosen preferably match the service requirements provided by monitoring system 100 (or are derivable for use by monitoring system 100) such as the information used by the property value estimation services (e.g., automatic and/or manual appraisers).

Additional services area 330 identifies other features available from monitoring system 100 and applicable to the property. For example, services area 330 includes active hypertext links (when report 300 is implemented as a webpage or other electronic document or documents) to an archive of previous reports, a link to comparable home sales and/or neighborhood demographics report/analysis.

Additional resources area 335 identifies other resources available to the client that are informational to understand some of the issues addressed by monitoring system 100, to locate professionals or services related to the topics/issues of monitoring system 100, and/or guides/manuals for achieving some of the results identified by monitoring system 100 when they are not automatically initiated.

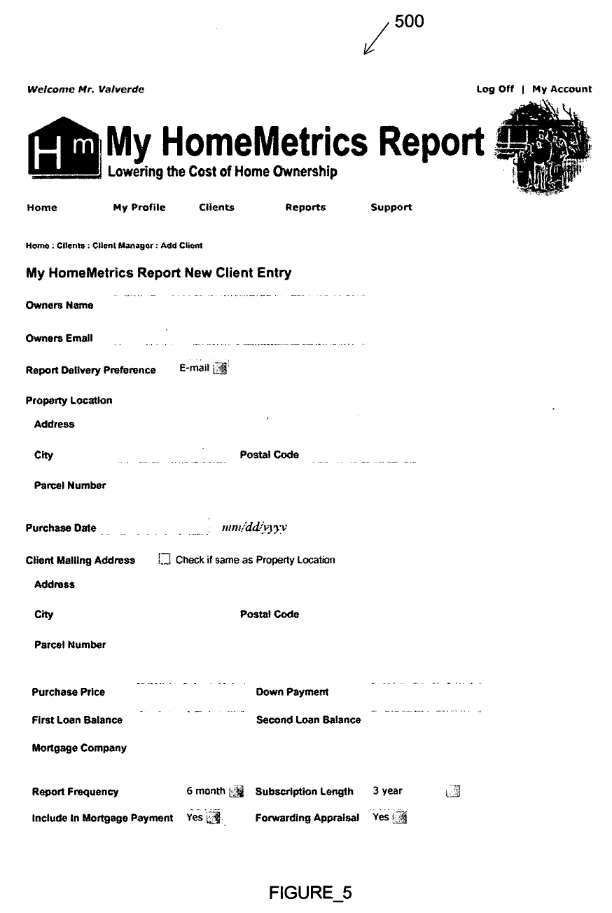

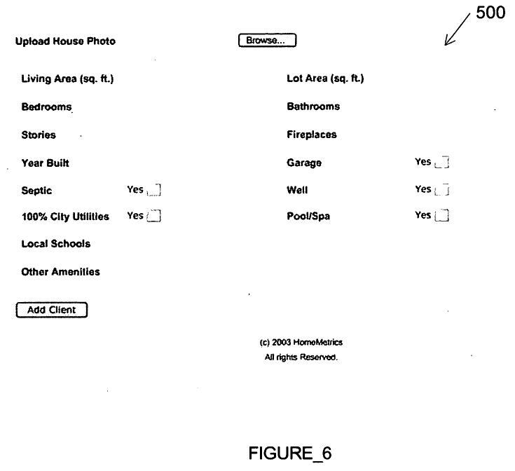

FIG. 5 is a first page of a copy of a client entry interface 500 for monitoring system 100. FIG. 6 is a second page of interface 500 shown in FIG. 5. Interface 500 enters a new client record and sets up monitoring system 100 parameters according to the implementation and options selected by the client. A user's identification, property description and relevant real property information (loan information, purchase price, initial equity, property features and other appropriate information) is recorded/entered into system 100.

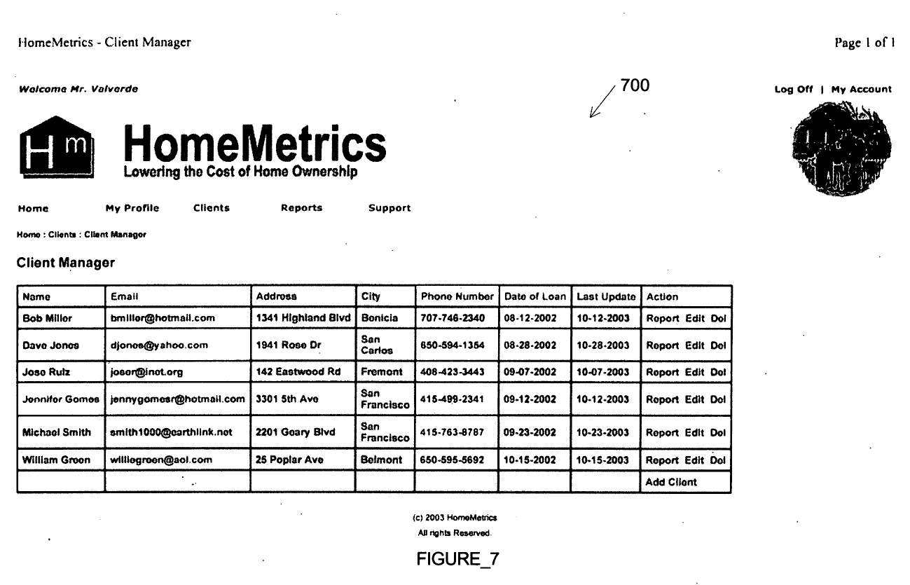

FIG. 7 is a copy of a client manager interface 700 for use with monitoring system 100. Interface 700 associates one or more clients of monitoring system 100 with a particular product/service professional, permitting that professional to access selected information of the clients and to add information directly to message box 310 of report 300 shown in FIG. 3. A client may be available to multiple professionals, such as for different products/services and monitoring system 100 may provide different compositions of client information to these different professionals.

Monitoring system 100 provides financial services leveraging information and technology to provide high quality products and services. Monitoring system 100 aids homeowners in reducing a cost of homeownership. Monitoring system 100 provides report 300 to homeowners as part of that assistance. One embodiment of report 300 provides information regarding the homeowner's real property, for example, a current market value estimate, mortgage information, estimate of accrued home equity, ownership information, and property characteristics. Located on report 300 is, in some implementations, a dedicated space for a message box 310 to be used as a highly targeted direct marketing tool for either advertising or a personalized message from a service provider such as a real estate agent, mortgage broker, etc. Message box 310 appears on the user's report 300 and includes targeted content from one or more particular providers that, preferably, uses information from report 300 provided to the one or more providers as authorized by the user.

In addition to the report 300, monitoring system 100 also provides additional optional services from a portfolio of available services for the homeowner, which may include:

Property Tax Assessment Monitoring, Analysis and Reduction

Private Mortgage Insurance Monitoring and Removal/Cancellation

Homeowners Insurance benchmarking and cost reduction alternatives

Mortgage Monitoring (including an estimated balance in any impound accounts and whether the homeowner is accruing more than or less than is required, an amount of principal paid down, an amount of interest paid since the last report and in totality, and the currently applicable mortgage interest rate with the next adjustment date and the current comparable market interest rate, when applicable).

Monitoring system 100 also provides, in a preferred embodiment, a portfolio of services to businesses that may assist the homeowner, including:

Highly targeted direct marketing, in the form of homeowner specific contact via the monitoring system 100 report 300 message box 310 (helping a business to retain or acquire a customer). This will be useful for businesses with a large installed customer base such as financial services firms, real estate brokerages and banks, as well as for newer businesses desiring to increase market share. Message box 310 helps such businesses to maintain and grow existing client relationships.

Qualified sales leads to our partners based on the identified needs of homeowners as indicated by monitoring system 100 report 300 and property characteristics database (for example):

When a homeowner's insurance is considerably above the industry benchmark, monitoring system 100 provides businesses a chance to bid for the coverage, with a selected number of bids (e.g., the three best bids) presented to the homeowner as possible alternative providers.

When a homeowner's property tax assessment is above market value, monitoring system 100 creates a nationwide network of residential property tax consultants to act as a direct referral to pre-screened, local property tax agents.

Monitoring system 100 provides marketing opportunities for other products and service offerings related to a home with product/service offerings targeted by zip code, home characteristics (e.g., pool, two stories, and the like).

Monitoring system 100 creates a technology, infrastructure, and distribution channels to support the product and service offerings. Monitoring system 100 is a financial services/products system, method, and computer program product for leveraging information and technology to provide high quality products and services to our customers at a reasonable price. Monitoring system 100 helps homeowners reduce the cost of homeownership. Monitoring system 100 report 300 is central to helping the homeowners in this regard. A simple implementation of report 300 provides property information in an easy to use format. This information includes: a current valuation estimate, mortgage information, estimate of accrued home equity, ownership information, property characteristics and alerts to specific equity thresholds.

Located on each monitoring system 100 report 300 (for example, near the bottom) is a dedicated space for message box 310 to be used for direct marketing, general advertising, or a personalized message from a service provider such as a real estate agent, mortgage broker, or other professional. Report 300 is preferably available over the Internet and may also/in lieu of be distributed as a soft copy via email or as a hard copy via regular mail. Report 300 is typically one to two pages in length and is delivered at a client-determined frequency.

Monitoring system 100 report 300 provides the homeowner with information regarding the equity accrued in their home on a periodic basis. For most Americans their home is their largest investment, yet they have only a passing knowledge of their home's value or the amount of equity they have accumulated. For all other investment types whether it is a brokerage account, insurance policy, or saving account, the user receives a report on a periodic basis. Monitoring system 100 fills a need that as of yet has not been addressed. Subscribers will find this product useful in estate and retirement planning. This product increases a subscriber's responsiveness to changing economic climates as those climates impact residential real estate.

Monitoring system 100 report 300 provides particular value as a client retainment tool for financial services professionals, specifically mortgage brokers and real estate agents who assisted the homeowner acquire the current residence, as well as for other professionals wishing to acquire new customers.

A property tax assessment monitoring, analysis and reduction service is included in some preferred embodiments of monitoring system 100. This service is an option for monitoring system 100 report 300. This service compares the property tax assessment with the market value as of the lien date and alerts homeowners when there is an opportunity to reduce their property taxes. Additional features include filing an appeal, correspondence with the assessor's office, and appeal representation if necessary.

This service alerts subscribers of any potential over or under assessment. Subscribers that are notified of an over assessment have the opportunity to purchase services that will help them reduce the property tax assessment. Many subscribers would not be aware that their property was over-assessed if it were not for this service. While others who may have an idea that they were over assessed may not have the time, skills, or knowledge to reduce their assessment. Monitoring system 100 provides a complete solution from notification of over-assessment to the delivery of a refund check. To date there are a number of small, independent operators that solicit business on a regional basis, only periodically, when property tax savings are virtually guaranteed. Many homeowners would not be aware of the opportunity to reduce their property taxes if they were not notified. Monitoring system 100 provides the monitoring service on a continuous, periodic basis as specified by the subscriber, for all assessment-to-value ratios.

Monitoring system 100 of a preferred embodiment provides private mortgage insurance monitoring and removal/cancellation as discussed above. This service is an option for monitoring system 100 report 300. The service compares the amount of accrued equity by taking the market value of the home and subtracting the mortgage principal balance and alerts homeowners when there is an opportunity to cancel their private mortgage insurance based on the current rules and laws governing the private mortgage insurance industry, as well as the guidelines followed by the industry associations and private mortgage insurance corporations or when they are able to eliminate the insurance by refinancing. Additional features that may be available via an additional subscription include correspondence with lender, additional valuation analysis when required, and advice on available options (and recommended options in some cases) to achieve cancellation of private mortgage insurance.

For home mortgages signed on or after Jul. 29, 1999, private mortgage insurance must—with certain exceptions—be terminated automatically when the mortgagor reaches twenty-two percent equity in the mortgagor's home based on the original property value, if mortgage payments are current. Private mortgage insurance also can be canceled, upon request—when the mortgagor reaches twenty percent equity in the mortgagor's home based on the original property value, if mortgage payments are current.

However, a homeowner may request to have their private mortgage insurance cancelled earlier, once they have accrued twenty percent equity in their home, taking into account market appreciation and loan pay down or they may refinance their home with a new loan that does not require mortgage insurance. Lenders have no incentive to cancel this insurance and are reluctant to do so. To date there are a number of small, independent appraisers that provide services to homeowners, upon the homeowner's direct initiative, to assist them in canceling their private mortgage insurance, for a fee and typically require that they purchase an appraisal from them, usually costing two to four hundred dollars. The fee is due, even when the appraisal does not support mortgage insurance cancellation/removal so some homeowner's are reluctant to initiate this process, or avoid it all together.

No provider currently offers pro-active monitoring services. A homeowner must initiate action to contact an appraiser when they feel that they are paying private mortgage insurance unnecessarily, which could be months or years after the first opportunity to cancel or eliminate their private mortgage insurance. The lack of active monitoring could cost uninformed homeowners hundreds or thousands of dollars in unnecessary private mortgage insurance payments in the event that they forget they have private mortgage insurance.

A homeowners insurance benchmarking and cost reduction alternatives service is included in some preferred embodiments of monitoring system 100. This service is an option of monitoring system 100 report 300 and compares properties of current insurance coverage and the associated premiums against industry benchmarks of similar coverage for similar properties in the area. Monitoring system 100 alerts the homeowner when they are paying substantially more than or less than the industry average for the area based on the benchmark data. Monitoring system 100 provides a complete solution by providing a list of competitive insurance providers and their quoted rates for the type and amount of insurance that the homeowner currently has (e.g., three alternatives to the present insurer). Monitoring system 100 not only informs homeowners how they can reduce the cost of homeownership but also provides them with resources to assist in realizing the cost savings. Monitoring system 100 in an insurance benchmarking implementation takes into account one or more of: 1) annual homeowners insurance payment; 2) type and amount of coverage; 3) geographic location; 4) deductible; 5) replacement construction costs according to the Marshal & Swift; construction cost survey; 6) quality of the insurer as determined by debt rating agencies, Moody's, Fitch's, or Standard & Poor's; 7) displacement benefits; and 8) other items deemed appropriate.

Homeowners will use this service to monitor the cost of homeowners insurance. Often, once a homeowner obtains their initial coverage they do not competitively shop their insurance rates, opting to passively renew year after year. This service will keep homeowners informed of the market price for homeowners insurance based on their level of coverage and their home characteristics. When it is possible to reduce the cost of their insurance coverage, monitoring system 100 tells them and provides them with alternative carriers and rate quotes.

A mortgage monitoring service is available in some preferred embodiments of monitoring system 100. This service is an option for monitoring system 100 report 300, and monitors, through estimates, the mortgage payments made by the homeowner, The mortgage monitoring service monitors: (a) the balance in the impound accounts (e.g., property taxes, insurance, private mortgage insurance, etc.) to compare the amount that is being accrued with the amounts actually due and inform the homeowner when they are under accruing or over accruing; (b) the amount of interest paid to date the amount of principal paid down and the amount of interest paid since the last report; and (c) the mortgage interest rate, the next adjustment date and the current comparable market interest rate, when applicable.

This mortgage monitoring service is useful to homeowners to keep track of their mortgage and all of its component pieces. Additionally, monitoring system 100 will be able to track the impound accounts and alert the homeowners to discrepancies in accrual amounts from actual payments. An appeal of this service will be to ease of use, peace of mind, and potential cost reduction opportunities. A homeowner will be able to view their mortgage information from a single source in conjunction with current market information and a list of potential cost reduction opportunities.

Monitoring system 100 of the preferred embodiment also provides a portfolio of services to businesses, including: message box 310, qualified sales leads, and turn-key implementation for large mortgage servicers for custom implementation of monitoring system 100.

The message box service provides a direct information/marketing opportunity (customer retainment tool), in the form of a homeowner specific contact via report message box 310. In the preferred embodiment, this is implemented as a small informational box (text/graphics) at an end of monitoring system 100 report 300 that may take up approximately 1/3 of a page. (Of course, in other implementations, this size may be increased or decreased, and in some implementations, multiple boxes may be enabled.)

This direct information/marketing opportunity has a wide appeal to financial services professional, specifically; mortgage brokers, real estate agents, asset managers, and the like, who desire a way to stay in contact with their clients and customers, as well as to obtain new clients and customers. In some implementations, this space includes targeted advertising based on the homeowners characteristics (e.g., physical location, pool, number of stories, and other home or homeowner characteristic or demographic).

The qualified sales leads service provides qualified sales leads and marketing opportunities to our partners based on the identified needs of homeowners as indicated by monitoring system 100 report 300. Businesses are provided an opportunity to compete with several other providers for a customer with a clearly identified need and the ability and willingness to pay. A direct marketing lead puts the service provider at the top of the consumers mind at the time when they are contemplating making a purchase or retaining a consultant/advisor for a particular task. Preferred provider will have the ability to distribute their product monitoring system 100. In some implementations, monitoring system 100 integrates a payment process into its billing system so that purchases will be quick and easy for the homeowner.

The turnkey monitoring service of monitoring system 100 provides a custom monitoring system 100 report 300 (or complete system) to businesses with a large installed customer base such as financial services firms and real estate brokerages. Large financial service companies are able to provide a value added service to their customers. A custom monitoring system 100 report 300 is one way to serve this purpose. In the preferred embodiment, the turnkey monitoring service allows a service provider to be a distributor of its own custom report 300, while other aspects of the report generation are controlled by monitoring system 100.

To simplify the previous discussion, specific implementations of monitoring system 100 (and some alternate embodiments) were described. The triggering events and mortgagor records were specifically described in the context of private mortgage insurance removal/cancellation. It is understood that other metrics, records, and triggering events are included within the scope of the present invention, including the additional implementations described herein such as the homeowner's insurance, mortgage interest rate, and property tax assessment. Also, the description focused on real property ownership to simplify the discussion, but other interests in real property other than ownership in fee simple absolute are also contemplated to be within the scope of the present invention, including rentals, leases, time-shares, co-tenancy, joint-tenancy, tenants-in-common, cooperatives and other real property interests.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

What is claimed is:

1. A monitoring service, comprising:
(a) aggregating a mortgage metric record for each of a plurality of homeowners into a set of metric records, wherein said plurality of homeowners include homeowners retaining homeowner-related services from a plurality of different sources;
(b) monitoring a set of one or metric-modification triggering events and flagging one of said metric records that satisfy any criterion associated with any potential metric-modification triggering event as a potential metric report record, wherein a criterion relates to homeowner-related service; and
(c) notifying a homeowner associated with said potential metric record that said homeowner may have an option to modify a homeowner-related service.

2. The monitoring service of claim 1 wherein each metric record identifies one or more mortgage insurance prerequisites for payment of a mortgage insurance component and wherein a set of potential metric-modification triggering events includes an event that determines whether said one or more mortgage insurance prerequisites are satisfied.

3. The monitoring service of claim 1 wherein each metric record identifies one or more mortgage insurance prerequisites for payment of a mortgage insurance component and wherein said set of potential metric-modification triggering events includes an event that determines whether said one or more mortgage insurance prerequisites are no longer satisfied.

4. The monitoring service of claim 1 wherein each metric record identifies one or more mortgage insurance prerequisites for payment of a mortgage insurance component and wherein said set of potential metric-modification triggering events includes an event that determines whether said one or more mortgage insurance prerequisites will not be satisfied in an identified future period.

5. The monitoring service of claim 1 wherein said metric record is obtained from a primary source of information.

6. The monitoring service of claim 1 wherein said metric record is obtained from a secondary source of information.

7. The monitoring service of claim 1 wherein each metric record identifies one or more mortgage insurance prerequisites for payment of a mortgage insurance component and wherein one of said prerequisites is a ratio of a loan obligation to an asset valuation.

8. The monitoring service of claim 7 wherein one of said triggering events includes appreciation of said asset valuation.

9. The monitoring service of claim 7 wherein one of said triggering events includes reducing the principal amount owed on the loan.

10. The monitoring service of claim 8 wherein said appreciation of said asset value is an estimation responsive to data in said metric record.

11. The monitoring service of claim 1 wherein said notifying step includes issuing a correspondence to said homeowner.

12. The monitoring service of claim 10 wherein said correspondence includes a Uniform Resource Locator (URL) to a mortgage insurance removal webservice.

13. The monitoring service of claim 11 wherein said correspondence is an e-mail and said URL is an active link.

14. The monitoring service of claim 11 wherein said mortgage insurance removal webservice includes a subscription service having said metric record for said mortgagor.

15. The monitoring service of claim 13 wherein said subscription service includes a mortgage insurance resource.

16. The monitoring service of claim 14 wherein said metric record is obtained from information submitted by a homeowner who is a mortgagor paying a mortgage insurance component and wherein said mortgage insurance resource is applied to said mortgage insurance payer record automatically.

17. The monitoring service of claim 14 wherein said mortgage insurance resource is available via selection of a sponsored link of said subscription service.

18. A monitoring service, comprising:
means for aggregating a metric record for each of a plurality of homeowners into a set of metric records, wherein said plurality of homeowners include homeowners paying a plurality of different home-related service providers;
means for monitoring a set of one or more potential metric-modification triggering events and flagging one of said metric-modification records that satisfy any criterion associated with any potential metric-modification triggering event as a potential metric-modification record, wherein a criterion relates to real property; and
means for notifying a homeowner associated with said potential metric-modification record that said homeowner may have an option to modify a homeowner-related service in a beneficial way.

19. A computer program product comprising a computer readable medium carrying program means for carrying out a monitoring service, the computer program product comprising:
code means for aggregating a metric record for each of a plurality of homeowners into a set of metric records, wherein said plurality of homeowners include homeowners paying a plurality of different home-related service providers;
code means for monitoring a set of one or more potential metric-modification triggering events and flagging one of said metric-modification records that satisfy any criterion associated with any potential metric-modification triggering event as a potential metric-modification record, wherein a criterion relates to real property; and
code means for notifying a homeowner associated with said potential metric-modification record that said homeowner may have an option to modify a homeowner-related service in a beneficial way.

20. An apparatus, comprising:
a datastorage system for aggregating a metric record for each of a plurality of homeowners into a set of metric records, wherein said plurality of homeowners include homeowners paying a plurality of different home-related service providers;
a computing system for monitoring a set of one or more potential metric-modification triggering events and flagging one of said metric-modification records that satisfy any criterion associated with any potential metric-modification triggering event as a potential metric-modification record, wherein a criterion relates to real property; and
a communications system for notifying a homeowner associated with said potential metric-modification record that said homeowner may have an option to modify a homeowner-related service in a beneficial way.

21. A monitoring method, the method comprising:
(a) aggregating a metric record for each of a plurality of homeowners into a set of metric records, wherein said plurality of homeowners include homeowners paying a plurality of different home-related service providers;
(b) monitoring a set of one or more potential metric-modification triggering events and flagging one of said metric-modification records that satisfy any criterion associated with any potential metric-modification triggering event as a potential metric-modification record, wherein a criterion relates to real property; and
(c) notifying a homeowner associated with said potential metric-modification record that said homeowner may have an option to modify a homeowner-related service in a way beneficial to said homeowner.

22. The monitoring method of claim 21 wherein said metric record includes a mortgage insurance payment related to a mortgage for each particular homeowner.

23. The monitoring method of claim 22 wherein said notifying step (c) includes a reference to removal of a mortgage insurance payment responsive to a modified property valuation included in a metric record.

24. The monitoring method of claim 21 wherein a metric record includes a property tax assessed value for each real estate property associated with each homeowner.

25. The monitoring method of claim 24 wherein said notifying step (c) includes a reference to a reduction of a property tax assessed value responsive to a modified property valuation.

26. The monitoring method of claim 21 wherein said metric record includes a homeowner's insurance premium record related to a homeowner's insurance premium for each particular homeowner.

27. A computer program product comprising a computer readable medium carrying program instructions for monitoring real property metrics when executed using a computing system, the executed program instructions executing a method, the method comprising:
(a) aggregating a metric record for each of a plurality of homeowners into a set of metric records, wherein said plurality of homeowners include homeowners paying a plurality of different home-related service providers;
(b) monitoring a set of one or more potential metric-modification triggering events and flagging one of said metric-modification records that satisfy any criterion associated with any potential metric-modification triggering event as a potential metric-modification record, wherein a criterion relates to real property; and
(c) notifying a homeowner associated with said potential metric-modification record that said homeowner may have an option to modify a homeowner-related service in a way beneficial to said homeowner.

28. The computer program product of claim 27 wherein said metric record includes a mortgage insurance payment related to a mortgage for each particular homeowner.

29. The computer program product of claim 28 wherein said notifying step (c) includes a reference to removal of a mortgage insurance payment responsive to a modified property valuation included in a metric record.

30. The computer program product of claim 27 wherein a metric record includes a property tax assessed value for each real estate property associated with each homeowner.

31. The computer program product of claim 30 wherein said notifying step (c) includes a reference to a reduction of a property tax assessed value responsive to a modified property valuation.

32. The computer program product of claim 27 wherein said metric record includes a homeowner's insurance premium record related to a homeowner's insurance premium for each particular homeowner.

33. A contacting method, the method comprising:
(a) aggregating a metric record for each of a plurality of homeowners into a set of metric records, wherein said plurality of homeowners include homeowners paying a plurality of different home-related providers for one or more home-related goods or services;
(b) providing each homeowner of said plurality of homeowners with a report regarding said one or more home-related goods or services; and
(c) integrating a messagebox into each said report, with a content of said messagebox provided by a particular one provider.

34. A computer program product comprising a computer readable medium carrying program instructions for monitoring real property metrics when executed using a computing system, the executed program instructions executing a method, the method comprising:
(a) aggregating a metric record for each of a plurality of homeowners into a set of metric records, wherein said plurality of homeowners include homeowners paying a plurality of different home-related providers for one or more home-related goods or services;
(b) providing each homeowner of said plurality of homeowners with a report regarding said one or more home-related goods or services; and.
(c) integrating a messagebox into each said report, with a content of said messagebox provided by a particular one provider.

35. A contacting apparatus, comprising:
means for aggregating a metric record for each of a plurality of homeowners into a set of metric records, wherein said plurality of homeowners include homeowners paying a plurality of different home-related providers for one or more home-related goods or services;
means for providing each homeowner of said plurality of homeowners with a report regarding said one or more home-related goods or services; and
means for integrating a messagebox into each said report, with a content of said messagebox provided by a particular one provider.
